(19) United States
(12) Patent Application Publication
(10) Pub. No.: US 2006/0146539 A1
(43) Pub. Date: Jul. 6, 2006

(54) Direct backlight module for flat panel monitor

(76) Inventor: Allen Weng, Lujhu Township (TW)

Correspondence Address: HDSL, 4331 STEVENS BATTLE LANE, FAIRFAX, VA, 22033, US

(21) Appl. No.: 11/028,658

(22) Filed: Jan. 5, 2005

(51) Int. Cl. F21V 5/00; F21V 7/04

(52) U.S. Cl. 362/329; 362/330; 362/607

(57) ABSTRACT

A direct backlight module for a flat panel monitor includes a first plate, an opposite second plate, and an illuminating layer that is sandwiched between the first plate and the second plate. The first plate is preferably a reflector. The second plate is preferably a diffuser. The illumination layer may be a single layer cold light plate, or a multi-layer cold light plate, or a LED plate that comprises a planar substrate, a plurality of LED bare chips, and a BEF sheet. The LED bare chips are mounted on one surface of the planar substrate, and the BEF sheet is then secured onto the planar substrate, thereby encapsulating the LED bare chips between the planar substrate and the BEF sheet.

### BACKGROUND OF THE INVENTION

The present invention relates in general to a direct backlight module for a flat panel monitor, and more specifically, to a backlight module whose light source is an illuminating layer.

Depending on the arrangement of their light sources, conventional backlight modules can be divided into two major groups, edge lighting and direct lighting. A typical direct backlight module is illustrated in FIG. 1. The direct backlight module includes a box body 1; a concaved light guide plate 10 within which a hollow chamber 11 is formed; at least one light source 12 installed inside the hollow chamber 11, which can be a PL bulb, a cold cathode fluorescent lamp, and the like; a multi-layer brightness enhancement film (BEF) 13 disposed at the light exit surface of the box body 1; and a diffuser 14. The backlight module is further aligned parallel and combined with a liquid crystal display (LCD) panel 15. The conventional direct backlight module is relatively thick. Further, the conventional direct backlight modules use a pipe light source 12 so that the middle area of the LCD panel 15 receive more illumination than the edge areas thereof receive. To make the LCD panel 15 receive a more uniform brightness, the light source 12 is kept away from the light exit surface. In addition, half of the illumination generated by the light source 12 shines backward and must be reflected for utilization. Therefore, approximately sixty percent of the illumination generated by the light source 12 is wasted within the chamber 11.

Various different inventions of direct backlight module tried to remedy aforementioned problems; for example, Taiwan Patent Nos. 244476, 224232, and 222617, and Taiwan Patent Publication Nos. 594261, 594106, and 587666. These inventions disclose a variety of structures and designs trying to prevent foresaid problems. Nonetheless, most of these inventions adopt a pipe type light bulb as their light sources, and therefore are unable to reduce their thickness and provide the LCD panel with a uniform brightness. Additionally, Taiwan Patent No 222617 disclosed a backlight module using light emitting diode (LED) as its light source. A plurality of LED elements is secured onto a circuit board in a manner of multi locations and angles. The light exit surface of LED elements must be equipped with a light guide plate; said Taiwan patent did not disclose a structure or design that is similar or same to the subject invention.

### BRIEF SUMMARY OF THE INVENTION

The present invention provides a direct backlight module for a flat panel monitor. The light source of the direct backlight module is an illuminating layer so that the present invention doesn't only provide simple and quick installation procedures, but also produces a much thinner flat panel monitor.

The direct backlight module provided by the present invention includes a first plate, an opposite second plate, and an illuminating layer that is sandwiched between the first plate and the second plate. The first plate is preferably a reflector. The second plate is preferably a diffuser. The illumination layer may be a single layer cold light plate, or a multi-layer cold light plate, or a LED plate that comprises a planar substrate, a plurality of LED bare chips, and a BEF sheet. The LED bare chips are mounted and evenly spaced from each other on one surface of the planar substrate, and the BEF sheet is secured onto the planar substrate, thereby encapsulating the LED bare chips between the planar substrate and the BEF sheet.

The objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 shows a cross-sectional view of a conventional direct backlight module.

FIG. 2 shows an exploded view of the first embodiment of a direct backlight module in accordance with the present invention.

FIG. 3 shows a cross-sectional view of the direct backlight module of FIG. 2 fully combined.

FIG. 4 shows an exploded view of the second embodiment of a direct backlight module in accordance with the present invention.

FIG. 5 shows a cross-sectional view of the direct backlight module of FIG. 4 fully combined.

FIG. 6 shows an exploded view of the third embodiment of a direct backlight module in accordance with the present invention.

FIG. 7 shows a cross-sectional view of the direct backlight module of FIG. 6 fully combined.

FIG. 8 shows an exploded view of the fourth embodiment of a direct backlight module in accordance with the present invention.

FIG. 9 shows an exploded view of the fifth embodiment of a direct backlight module in accordance with the present invention.

FIG. 10 shows a cross-sectional view of the direct backlight module of FIG. 9 fully combined.

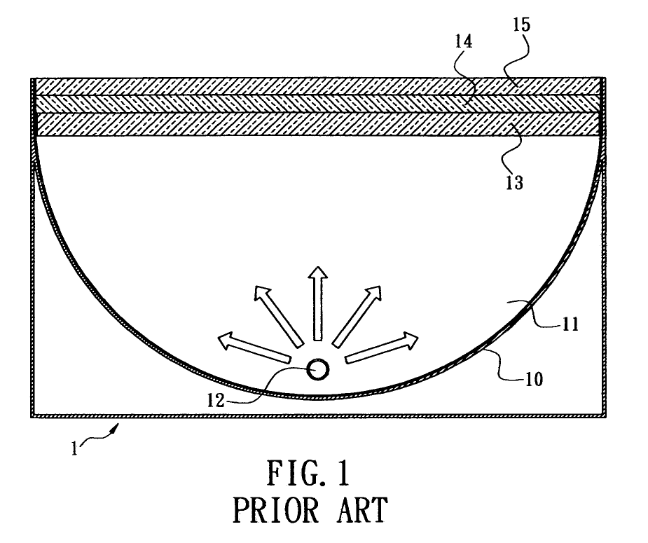

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

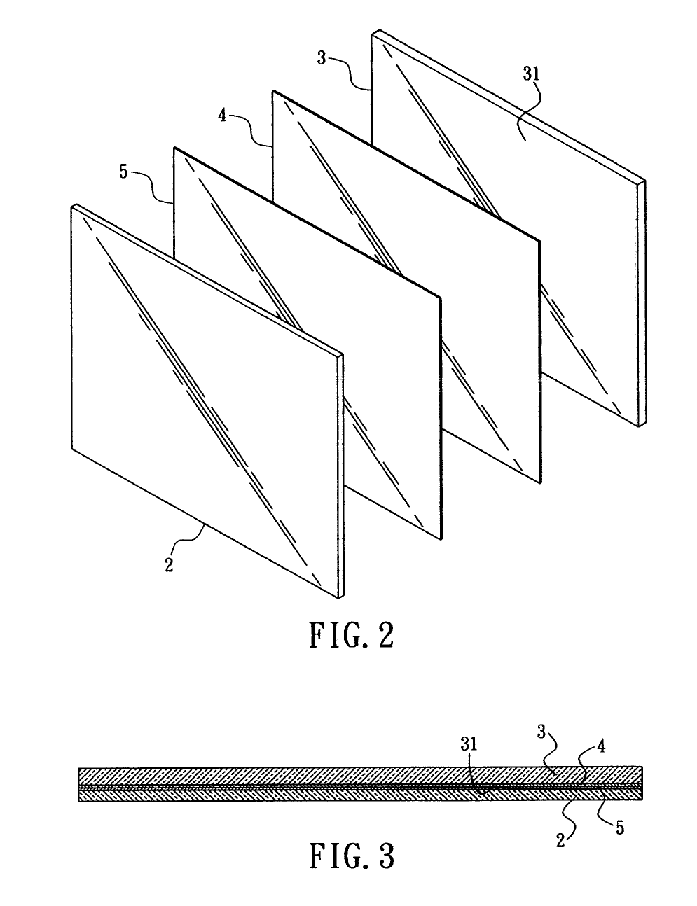

Referring to FIGS. 2 and 3, the first embodiment of a direct backlight module for a flat panel monitor of the present invention is illustrated. The direct backlight module, which is applied to illumination of a LCD panel 2, includes a first plate 3, an opposite second plate 5, and an illuminating layer 4 that is sandwiched between the first plate 3 and the second plate 5.

The first plate 3 is a planar plate, and is a back plate of the present backlight module. It is a base onto which the illuminating layer 4 and the second plate 5 are assembled. The first plate 3 provides a receptive space 31 for receiving the illuminating layer 4. In the present embodiment, the first plate 3 is a reflector, and the space before the front of the first plate 3 defines the receptive space 31.

The illuminating layer 4 is installed inside the receptive space 31 of the first plate 3, sandwiched between the first plate 3 and the second plate 5. The illuminating layer 4 is a planar light source, which provides the LCD panel 2 with a uniform brightness. In the present embodiment, the illuminating layer 4 is a single layer cold light plate. It generates a white light or other single color light shining on the back surface of the LCD panel 2.

The second plate 5 is installed before the illumination layer 4, and is able to scatter the light generated by the illumination layer 4 for obtaining an even illumination. In the present embodiment, the second plate 5 is a diffuser plate.

The present invention provides simple and quick installation procedures, for the illumination layer 4 is a planar layer sandwiched between the first plate 3 and the second plate 5. Compared with the conventional direct backlight module using a pipe light source, the present invention has a much thinner appearance and provides the LCD panel 2 with a more uniform brightness, for the illumination layer 4 is planar light source. Moreover, the present invention further provides a displaying function. Under an idle condition or before receiving any visual signal, the flat panel monitor may by itself let the illumination layer 4 thereof play a light show such as flashing in order to enrich the entertainment effect of the flat panel monitor.

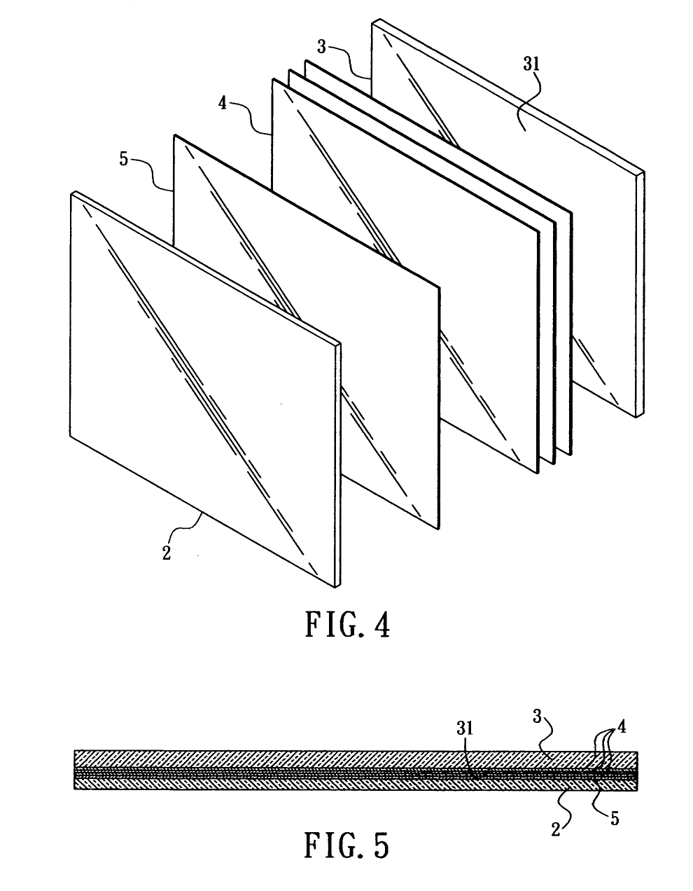

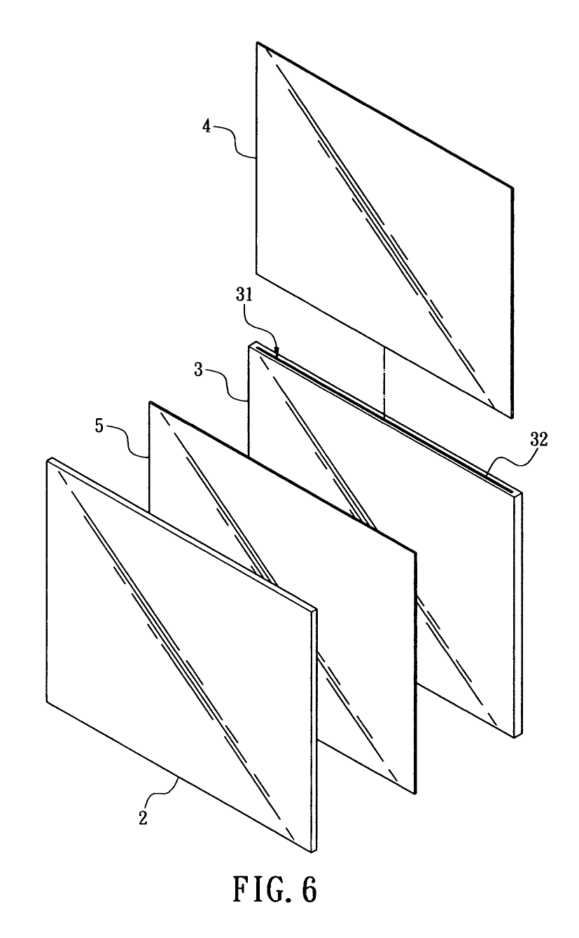

Referring to FIGS. 4 and 5, the second embodiment of a direct backlight module for a flat panel monitor of the present invention is illustrated. The illumination layer 4 of the second embodiment adopts a multi-layer cold light plate for providing the LCD panel with a multi-color light source; for example, red, green, and blue, three primary colors.

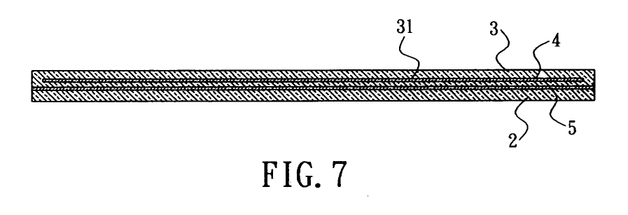

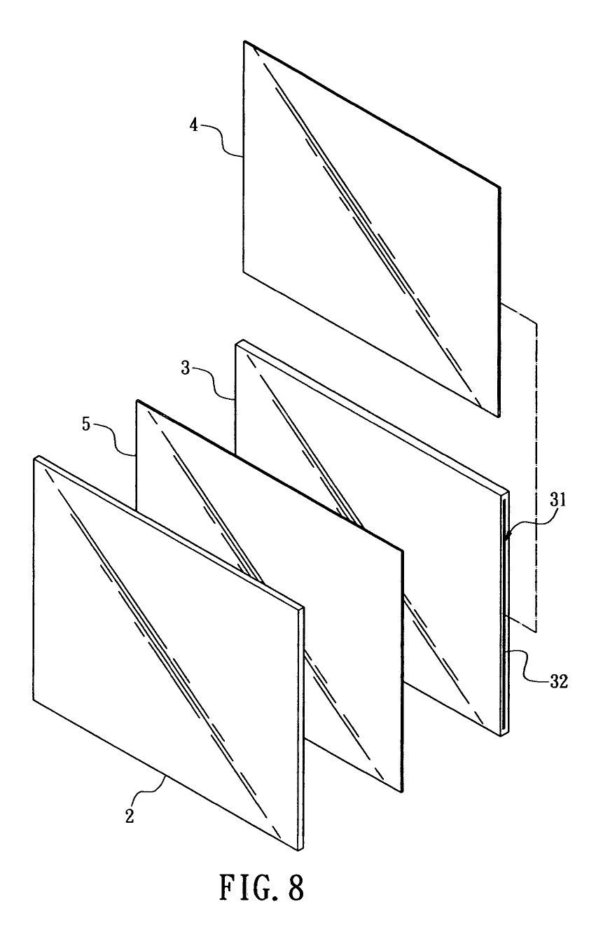

Referring to FIGS. 6 through 8, the third and the fourth embodiment of a direct backlight module for a flat panel monitor of the present invention are illustrated. Similar to foresaid embodiments, the direct backlight module includes a first plate 3, an opposite second plate 5, and an illuminating layer 4. The first plate 3 has a flat hollow inner space with an opening 32. The opening 32 may be cut from any edge of the first plate 3, top or bottom or left or right edge. The hollow inner space defines the receptive space 31 into which the illumination layer 4 is installed via the opening 32. The first plate 3 with an illumination layer 4 installed therein is further combined with the second plate 5 that is preferably a diffuser plate.

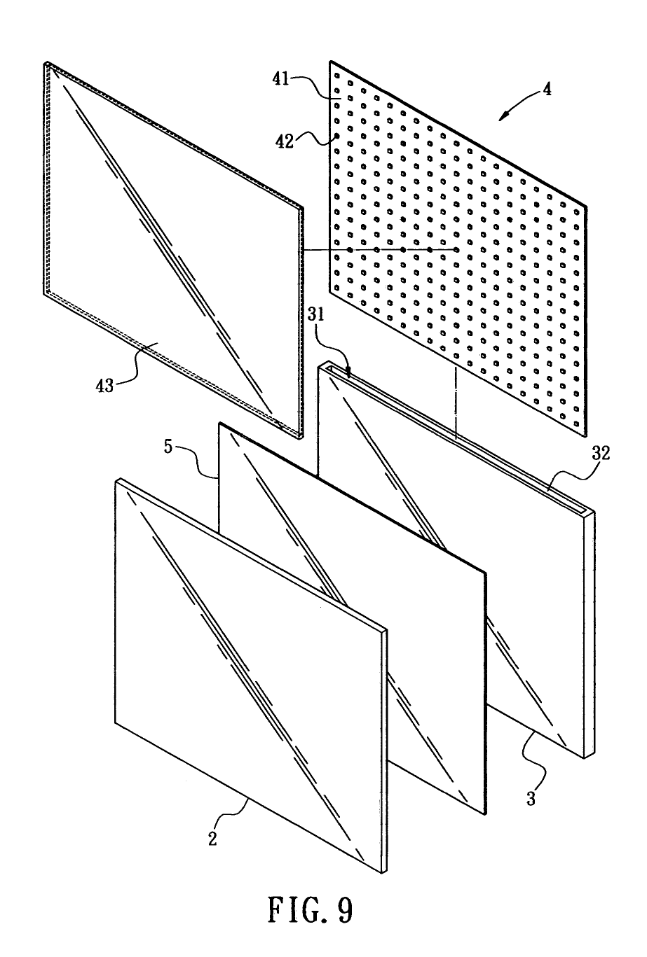

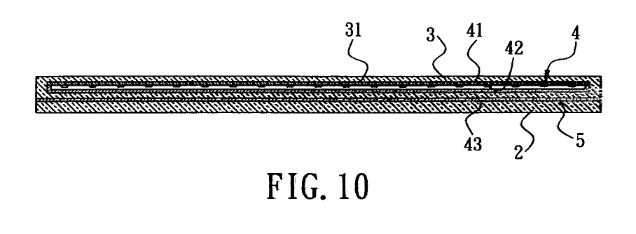

Referring to FIGS. 9 and 10, the fifth embodiment of a direct backlight module for a flat panel monitor of the present invention is illustrated. Unlike aforementioned embodiments, the illumination layer 4 of the fifth embodiment utilizes a plurality of LEDs as its light source, as shown in FIG. 9. The illumination layer 4 includes a planar substrate 41, a plurality of LED bare chips 42, and a BEF sheet 43. The planar substrate 41 is preferably an electrically connective board such as an electric circuit board or an integrated circuit board. A variety of LED bare chips can be utilized by the present embodiment, including white, colored, red green blue (RGB), or resonant cavity (RC) LED bare chip. By utilizing chip-on-board (COB) mounting method, the LED bare chips 42 are mounted and evenly spaced from each other on one surface of the planar substrate 41 in an orderly manner. The BEF sheet 43 is secured onto the planar substrate 41, thereby encapsulating the LED bare chips 42 between the planar substrate 41 and the BEF sheet 43 The illumination layer 4 is then inserted into the receptive space 31 of the first plate 3 via the opening 32. The first plate 3 with an illumination layer 4 installed therein is further combined with the second plate 5.

While an illustrative and presently preferred embodiment of the invention has been described in detail herein, it is to be understood that the inventive concepts may be otherwise variously embodied and employed and that the appended claim are intended to be construed to include such variations except insofar as limited by the prior art.

What is claimed is:

1. A direct backlight module for a flat panel monitor, comprising:
a first plate;
an opposite second plate; and
an illuminating layer that is sandwiched between the first plate and the second plate.

2. The direct backlight module of claim 1, wherein the first plate is a reflector.

3. The direct backlight module of claim 1, wherein the second plate is a diffuser.

4. The direct backlight module of claim 1, wherein the illumination layer is a single layer cold light plate.

5. The direct backlight module of claim 4, wherein the single layer cold light plate generates a white light or other single color light.

6. The direct backlight module of claim 1, wherein the illumination layer is a multi-layer cold light plate.

7. The direct backlight module of claim 6, wherein the multi-layer cold light plate generates red, green, and blue, the primary colors light.

8. The direct backlight module of claim 1, wherein the illumination layer comprises a planar substrate, a plurality of light emitting diode (LED) bare chips, and a brightness enhancement film (BEF) sheet, the LED bare chips being mounted on one surface of the planar substrate, the BEF sheet being secured onto the planar substrate and thereby encapsulating the LED bare chips between the planar substrate and the BEF sheet.

9. The direct backlight module of claim 8, wherein the LED bare chip is a white or colored or RGB or RC LED bare chip.

10. The direct backlight module of claim 1, wherein the flat panel monitor comprises a liquid crystal display (LCD) panel.

11. A direct backlight module for a flat panel monitor, comprising:
a first plate having a hollow receptive space with an opening cut from one edge thereof;
an illuminating layer that is installed inside the receptive space of the first plate; and
an opposite second plate fixed to the front of the first plate.

12. The direct backlight module of claim 11, wherein the opening of the receptive space is cut from the top or bottom or left or right edge of the first plate.

13. The direct backlight module of claim 11, wherein the first plate comprises a reflector.

14. The direct backlight module of claim 11, wherein the second plate is a diffuser.

15. The direct backlight module of claim 11, wherein the illumination layer is a single layer cold light plate.

16. The direct backlight module of claim 15, wherein the single layer cold light plate generates a white light or other single color light.

17. The direct backlight module of claim 11, wherein the illumination layer is a multi-layer cold light plate.

18. The direct backlight module of claim 17, wherein the multi-layer cold light plate generates red, green, and blue, three primary colors light.

19. The direct backlight module of claim 1, wherein the illumination layer comprises a planar substrate, a plurality of light emitting diode (LED) bare chips, and a brightness enhancement film (BEF) sheet, the LED bare chips being mounted on one surface of the planar substrate, the BEF sheet being incorporated onto the planar substrate and thereby encapsulating the LED bare chips between the planar substrate and the BEF sheet.

20. The direct backlight module of claim 11, wherein the flat panel monitor comprises a liquid crystal display (LCD) panel.
